(19) United States
(12) Patent Application Publication
(10) Pub. No.: US 2022/0153018 A1
(43) Pub. Date: May 19, 2022

(54) DROP DETECTION CALIBRATION

(71) Applicant: Hewlett-Packard Development Company, L.P., Spring, TX (US)

(72) Inventors: Josep Maria Cuñer Utgés, Sant Cugat del Valles (ES); Guillermo Alejandre Morales, Sant Cugat del Valles (ES); Jorge Millan Lafuente, Sant Cugat del Valles (ES)

(73) Assignee: Hewlett-Packard Development Company, L.P., Spring, TX (US)

(21) Appl. No.: 17/417,883

(22) PCT Filed: Aug. 5, 2019
(86) PCT No.: PCT/US2019/045136

§ 371 Date: Jun. 24, 2021

(51) Int. Cl. B41J 2/045

(52) U.S. Cl. CPC B41J 2/04505; B41J 2/04586

(57) ABSTRACT

Disclosed herein is a method of calibrating a printing device, a detector for use in a printing device and a printing device. The method is for calibrating a printing device having a nozzle that is to eject a drop of a printing fluid and a sensor that is to detect a drop of the printing fluid at a detection position. The method comprises ejecting a drop of the printing fluid from the nozzle; determining a measurement signal during a detection window with the sensor; extracting an arrival time of the drop from the measurement signal; and determining an adjusted detection window by adjusting the detection window based on the arrival time.

### BACKGROUND

A printing device such as an ink-jet type printer may comprise a nozzle that is to eject a drop of a printing fluid onto a print medium. Functionality testing may be performed to assess a status of the nozzle, e.g. to identify a clogged or non-functioning nozzle.

### BRIEF DESCRIPTION OF DRAWINGS

In the following, a detailed description of various examples is given with reference to the figures. The figures show schematic illustrations of FIG. 1: a detector for use in a printing device according to an example;

FIG. 2: a measurement signal generated by a sensor in accordance with an example;

FIG. 3: a printing device according to an example;

FIG. 4: a printing device with two print heads in accordance with an example;

FIG. 5a: measurement signals determined by a drop detector in accordance with an example;

FIG. 5b: measurement signals determined during adjusted detection windows by a drop detector according to an example;

FIG. 6: a method of calibrating a printing device in accordance with an example; and

FIG. 7: another method of calibrating a printing device according to an example.

### DETAILED DESCRIPTION

Functionality testing of a nozzle of a printing device may comprise ejecting a drop from the nozzle and detecting the ejected drop with a sensor, e.g. to confirm the presence or absence of the drop or to determine parameters of the drop such as a drop volume or drop velocity. To facilitate detection of the ejected drop, the printing device may be calibrated, for example by determining a flight time of a drop between the nozzle and the detector and/or a relative position between the nozzle and the detector. Based on the calibration, parameters of a measurement to detect the ejected drop, e.g. the relative position between the nozzle and the detector and/or parameters of a detection window, may be adjusted.

FIG. 1 depicts a detector 100 for use in a printing device (not shown) according to an example. The detector 100 may for example be used with one of the printing devices 300 and 400 described below and/or for execution of a method of calibrating a printing device such as the methods 600 and 700 described below.

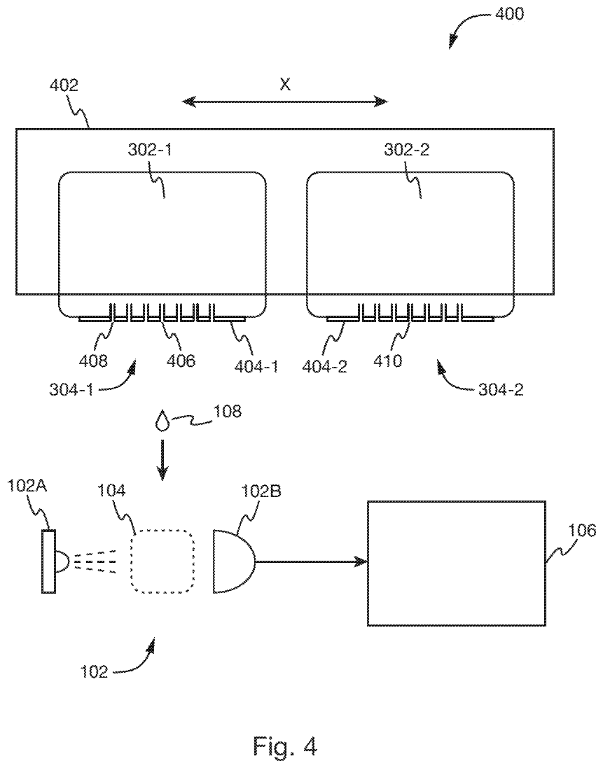

The detector 100 comprises a sensor 102 that is to generate a measurement signal during a detection window, wherein the measurement signal characterizes an amount of a printing fluid in a measurement zone 104. The sensor 102 may for example be a photoelectric relay comprising a light source and a photodetector, e.g. as described below with reference to FIG. 4. In other examples, the sensor 102 may be an electric sensor, e.g. an electrostatic sensor, an inductive sensor or capacitive sensor. The measurement zone 104 may be a volume or space adjacent to the sensor 104, e.g. a space between the light source and the photodetector if the sensor is a photoelectric relay. If the sensor 102 is an electric sensor, the measurement zone 104 may e.g. be a space adjacent to an electrode of the sensor 102 or may be the surface of an electrode of the sensor 102.

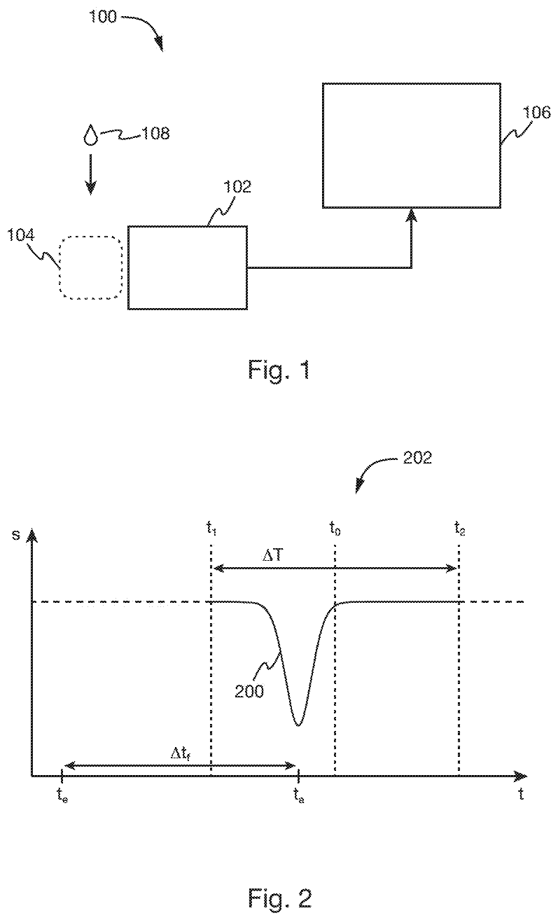

An example of a measurement signal 200 during a detection window 202 is illustrated in FIG. 2. The measurement signal 200 may for example be an analog signal such as an electric signal, e.g. a current or voltage, or a digital signal. The measurement signal 200 may depend on the amount of printing fluid in the measurement zone 104. The measurement signal 200 may quantify the amount of a printing fluid in the measurement zone 104. In some examples, an amplitude of the measurement signal 200 may be proportional to the amount of printing fluid in the measurement zone 104. The measurement signal 200 may e.g. be associated with a light intensity measured by a photodetector. Printing fluid in the measurement zone 104, e.g. a drop 108 of printing fluid passing through the measurement zone 104, may for example absorb and/or scatter light emitted by a light source, which may lead to a decrease in light intensity incident on the photodetector, e.g. at an arrival time tₐ of the drop 108. In other examples, the measurement signal 200 may be associated with a current or voltage measured by an electric sensor. In some example, the measurement signal 200 may be a discrete measurement signal comprising a plurality of data points, e.g. data points measured at a predetermined sampling rate. The predetermined sampling rate may for example be no smaller than 1 μs and/or no larger than 1 ms.

The detection window 202 may for example be a period of time over which the sensor 102 determines the measurement signal 200. The detection window 202 may e.g. extend from a starting time or starting point in time t₁ to an ending time or ending point in time t₂ and may have a duration or width ΔT. The starting time t₁ and the ending time t₂ may also be referred to as starting point and ending point, respectively, in the following. The width ΔT may for example be no smaller than 100 μs and/or not larger than 100 ms. Additionally or alternatively, the width ΔT may e.g. correspond to no less than 20 sampling intervals and/or no more than 10000 sampling intervals. In some examples, the sensor 102 may receive a trigger signal to start and/or stop a measurement, which may determine the starting point tₜ the width ΔT and/or the ending point t₂ of the detection window 202. Determining the measurement signal 200 during the detection window, instead of measuring continuously, may e.g. limit power consumption of the sensor 102 and/or may facilitate processing of the measurement signal 200, e.g. due to a smaller amount of data to be processed. In some examples, the sensor 102 may determine a continuous measurement signal over a period longer than the detection window 202 and the measurement signal 200 during the detection window 202 may be obtained by post-processing of the continuous measurement signal, e.g. by discarding parts of the continuous measurement signal outside of the detection window 202. The post-processing may e.g. be performed by the sensor 102 itself or a device reading out the continuous measurement signal from the sensor 102.

The detector 100 further comprises a controller 106 that is to read out the measurement signal 200 from the sensor 102. An input of the controller 106 may e.g. be coupled to an output of the sensor 102 by a cable or wire. The controller 106 may be implemented in hardware, software or a combination thereof. The controller 106 may e.g. comprise an electronic circuit that is to read out and/or process the measurement signal 200, e.g. an application-specific integrated circuit (ASIC). Additionally or alternatively, the controller 106 may comprise a microprocessor, e.g. a central processing unit (CPU) or a field-programmable gate array (FPGA), and a memory comprising instructions to be executed by the microprocessor, e.g. to read out and/or process the measurement signal 200 and/or to execute one of the methods 600 and 700 or a part thereof.

The controller 106 is to determine an arrival time tₐ of a drop 108 of a printing fluid in the measurement zone 104 from the measurement signal 200. When the drop 108, which may e.g. have been ejected from a nozzle of a printing device (not shown) at an ejection time tₑ, enters or passes through the measurement zone 104, the measurement signal 200 may exhibit a feature or drop signature, e.g. an extremum such as a minimum or maximum. The controller 106 may determine the arrival time tₐ by identifying an extremum in the measurement signal 200, e.g. the point in time at which the measurement signal 200 has a minimum or a maximum. The arrival time tₐ may for example be the ejection time tₑ plus a flight time Δt_{f}, i.e. the flight time Δt_{f} may be the time that the drop 108 moves from the nozzle to the measurement zone 104. In some examples, the controller 106 may also determine the flight time Δt_{f}. The controller 106 may e.g. determine or receive the ejection time tₑ and may determine the difference between the arrival time tₐ and the ejection time tₑ. In some examples, the ejection time tₑ may be used as a reference point to define other times such as the arrival time tₐ and the starting point t₁, i.e. the ejection time tₑ may be set to zero, tₑ=0, and other times may be determined relative to the ejection time tₑ.

The controller 106 is further to adjust at least one of the starting point t₁ and the width ΔT of the detection window 202 based on a comparison between the arrival time tₐ and a reference time t₀. The reference time t₀ may for example be a predetermined point in time within the detection window 202, e.g. the center of the detection window 202, the starting point t₁ or the ending point t₂.

In some examples, the controller 106 may adjust the starting point t₁ and/or the width ΔT if an amount of a difference between the arrival time tₐ and a reference time t₀ exceeds a predetermined threshold or is not within a predetermined range. The predetermined threshold may for example be a fraction of the width ΔT, e.g. between 1% and 15% of the width ΔT, e.g. 5% of ΔT. Accordingly, the predetermined range may for example be defined as fractions of the width ΔT. In other examples, the predetermined threshold and/or the predetermined range may be absolute values. In some examples, the controller 106 may adjust the starting point t₁ and/or the width ΔT if the arrival time tₐ is different from a reference time t₀.

The controller 106 may for example adjust the starting point t₁ to an adjusted starting point \tilde{t}₁ and/or the width ΔT to an adjusted width Δ\tilde{T}. The adjusted starting point \tilde{t}₁ and/or the adjusted width Δ\tilde{T} may define an adjusted detection window, e.g. relative to an actual ejection time. The adjusted detection window may have an ending point \tilde{t}₂, which is also referred to as the adjusted ending point in the following. In some examples, the adjusted ending point may be the same as the ending point t₂ of the detection window 202. The adjusted detection window may for example be used for a subsequent determination of a measurement signal, e.g. by adjusting the emission time of a drop, the beginning of the adjusted detection window and/or the duration of the adjusted detection window as compared to the determination of the measurement signal 200 during the detection window 202.

The controller 106 may for example adjust the starting point t₁ and/or the width ΔT of the detection window 202 such that the arrival time tₐ would correspond to an adjusted reference time t₀ of the adjusted detection window or would correspond to the sum of the adjusted reference time \tilde{t}₀ and a predetermined positive or negative offset. The predetermined offset may e.g. also be a fraction of the width ΔT or the adjusted width Δ\tilde{T}. In one example, the reference times t₀ and \tilde{t}₀ may be the center of the respective detection window and the controller 106 may adjust the starting point t₁ and/or the width ΔT such that the arrival time tₐ would correspond to the center of the adjusted detection window.

In other examples, the controller 106 may adjust the starting point t₁ and/or the width ΔT of the detection window 202 such that the arrival time tₐ would fall into a predetermined portion of the adjusted detection window, e.g. within a predetermined range around the center of the adjusted detection window. The length of the predetermined range may e.g. be a fraction of the adjusted width Δ\tilde{T}, for example no less than 25% of Δ\tilde{T} and/or no more than 75% of Δ\tilde{T}. In one example, the length of the predetermined range may e.g. be 50% of Δ\tilde{T}.

In some examples, the controller 106 may determine the arrival times of a plurality of drops and adjust the starting point t₁ and/or the width ΔT based on a plurality of arrival times, e.g. as described below for the printing device 400 or the method 700. The controller 106 may further be to iteratively adjust the starting point t₁ and/or the width ΔT of the detection window 202, e.g. by repeated determination of a measurement signal.

The controller 106 may determine whether the measurement signal 200 comprises a drop signature, e.g. a feature such as an extremum as described above. A drop signature may for example be used by the controller 106 to determine the arrival time tₐ, e.g. by identifying the point in time at which the drop signature occurs. The controller 106 may further be to adjust the detection window 202, if no drop signature, e.g. no extremum, is identified in the measurement signal 200. The controller 106 may for example increase the width ΔT and/or shift the starting point t₁ and/or ending point t₂ if no drop signature is identified in the measurement signal 200. In some examples, the controller 106 may iteratively adjust the starting point t₁ and/or the width ΔT until a drop signature is found, e.g. as described below for the method 700.

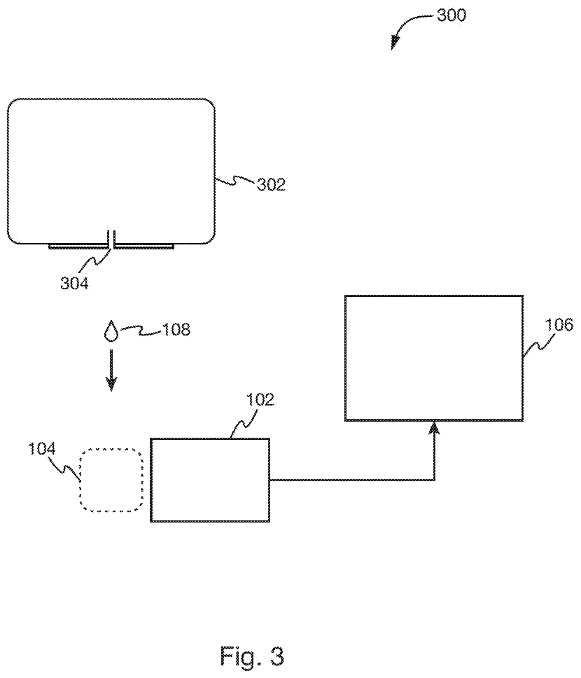

FIG. 3 depicts a printing device 300 in accordance with an example. The printing device 300 may for example be an ink-jet type printer, e.g. a large format printer. In other examples, the printing device 300 may be a 3D printer. The printing device 300 comprises a print head 302 that is to eject a drop 108 of a printing fluid from a nozzle 304 of the print head 302. The printing fluid may for example be an ink, e.g. a latex ink. The print head 302 may deposit printing fluid on a print medium (not shown) such as paper or another carrier, e.g. by moving the print head 302 above the print medium along a print head path across a printing zone (not shown).

The printing device 300 further comprises a drop detector 102 that is to determine a measurement signal during a detection window, wherein the measurement signal characterizes the presence or absence of a drop at the drop detector 102. In some examples, the drop detector 102 may be arranged in a maintenance area of the printing device 300, which may e.g. be used for servicing the print head 302 and may e.g. be located adjacent to the printing zone of the printing device 300. The drop detector 102 may for example be similar to the sensor of the detector 100 of FIG. 1 and may determine the measurement signal similar to the measurement signal 200 during the detection window 202 as shown in FIG. 2. In some examples, a measurement signal above a predetermined threshold may indicate the presence of a drop at the drop detector 102, e.g. in the measurement zone 104, and a measurement signal below the predetermined threshold may indicate the absence of a drop at the drop detector 102, e.g. in the measurement zone 104. In other examples, a measurement signal below a predetermined threshold may indicate the presence of a drop at the drop detector 102 and a measurement signal above the predetermined threshold may indicate the absence of a drop at the drop detector 102. The measurement signal may for example characterize an amount of a printing fluid in the measurement zone 104, e.g. as described above with reference to FIGS. 1 and 2.

The printing device 300 further comprises a controller 106, which may be implemented in hardware, software or a combination thereof. In some examples, the controller 106 may be a dedicated controller providing the functionality described below. The controller 106 may e.g. be similar to the controller of the device 100. In other examples, the controller 106 may be part of a controller that also provides additional functionality, e.g. a main controller of the printing device 300. The main controller of the printing device 300 may for example also control the print head 302 and/or execute print jobs. The controller 106 may e.g. be to execute the methods 600 and/or 700 or a part thereof.

The controller 106 is to determine a flight time Δt_{f} between ejection of a drop 108 from the nozzle 304 and arrival of the drop 108 at the drop detector 302 from the measurement signal, e.g. from the measurement signal 200. The drop 108 may for example be ejected from the nozzle 304 at an ejection time tₑ and may arrive at the drop detector 302, e.g. in the measurement zone 104, at an arrival time tₐ as described above with reference to FIG. 2. The controller 106 may e.g. be to read out the measurement signal 200 from the drop detector 102. The controller 106 may for example determine the flight time Δt_{f} by determining the arrival time tₐ, for example as described above for the device 100, and determining the difference between the arrival time tₐ and the ejection time tₑ.

The controller 106 is further to determine a starting time \tilde{t}₁ and an ending time \tilde{t}₂ for an adjusted detection window depending on the flight time Δt_{f}. The starting time \tilde{t}₁ and the ending time \tilde{t}₂ are determined relative to an ejection time, e.g. an ejection time of a drop to be ejected in the future. In other words, an ejection time may be used as a reference point to define \tilde{t}₁ and \tilde{t}₂. The starting time \tilde{t}₁ and the ending time \tilde{t}₂ may also be referred to as the adjusted starting time and adjusted ending time, respectively. The controller 106 may for example be to determine the adjusted starting time \tilde{t}₁ and the adjusted ending time \tilde{t}₂ as described above for the device 100, e.g. such that the arrival time tₐ would correspond to a reference point \tilde{t}₀ of the adjusted detection window.

FIG. 4 depicts a printing device 400 according to another example. The printing device 400 may be similar to the printing device 300 and may for example be an ink-jet type printer or a 3D printer. The printing device 400 may comprise a print head carriage 402 that is to receive a plurality of print heads, e.g. two print heads 302-1 and 302-2. The printing device 400 may for example move the print head carriage 402 in a scanning direction “X”, e.g. along a print head path from a printing zone to a maintenance area (not shown). Each of the print heads 302-1, 302-2 may comprise at least one nozzle plate 404-1 and 404-2, respectively. On the nozzle plates 404-1 and 404-2, a plurality of nozzles 304-1 and 304-2, respectively, may be arranged. The plurality of nozzles 304-1 includes nozzles 406 and 408 and the plurality of nozzles 304 includes a nozzle 410. The print heads 302-1, 302-2 may eject printing fluid from the nozzles 304-1, 304-2. For simplicity, a small number of nozzles is shown in FIG. 4. In some examples, the number of nozzles may be different than in FIG. 4, e.g. larger than in FIG. 4. Each of the print heads 302-1, 302-2 may for example comprise between 100 and 5000 nozzles.

The printing device 400 further comprises a drop detector 102, which may for example be similar to the drop detector of the printing device 300 and/or the sensor of the device 100. In the example of FIG. 4, the drop detector 102 is a photoelectric relay comprising a light source 102A such as a light-emitting diode and a photodetector 102B such as a photodiode. The light source 102A may emit light towards the photodetector 102B. The photodetector 102B may generate a measurement signal, e.g. a voltage or current, characterizing an intensity of light incident on the photodetector 102B. Accordingly, the measurement zone 104 may be located between the light source 102B and the photodetector 102B. The measurement zone 104 may for example comprise a space through which light emitted by the light source 102B traverses to the photodetector 102B. A drop 108 entering the measurement zone 104 may absorb and/or scatter light and may thereby reduce the intensity of the light incident on the photodetector 1026. The changing light intensity may manifest in a change of the measurement signal.

The printing device 400 also comprises a controller 106, which may for example be similar to the controller of the printing device 300 and/or the controller of the device 100. The controller 106 may further be to determine respective flight times for at least two nozzles of the plurality of nozzles 304-1, 304-2 using the drop detector 102. The at least two nozzles may be nozzles of the same print head, e.g. the print head 302-1, or may be nozzles of different print heads, e.g. the print heads 302-1 and 302-2. The at least two nozzles may e.g. be a subset of a group of nozzles and/or a subset of the nozzles of a print head. The controller 106 may e.g. determine the at least two flight times from respective measurement signals as described above for the printing device 300.

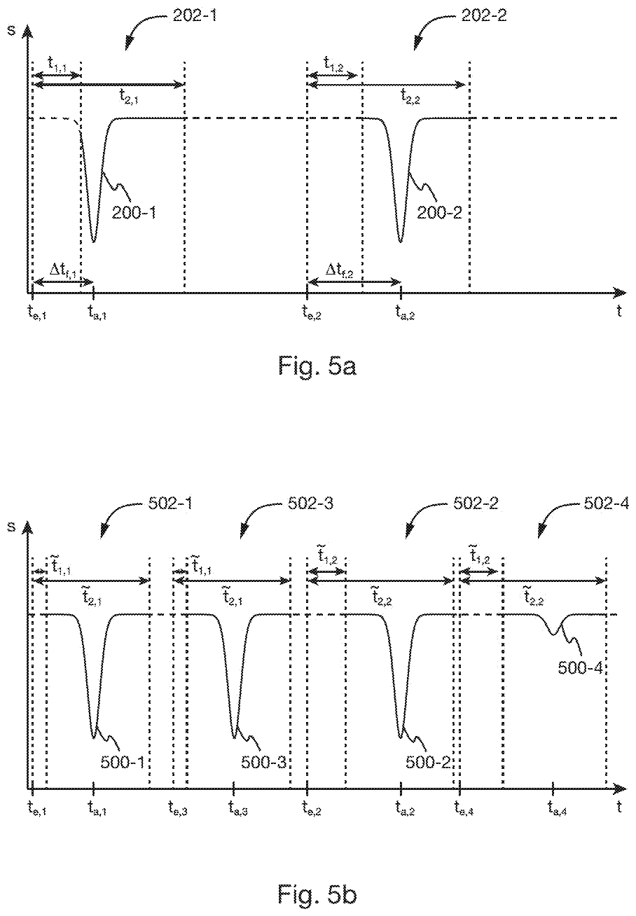

An example of measurement signals from two nozzles is shown in FIG. 5a, in which two measurement signals 200-1 and 200-1 are illustrated. The example may be generalized to any number of nozzles, e.g. any subset of the nozzles 304-1, 304-2 or all of the nozzles 304-1, 304-2. The first measurement signal 200-1 is determined during a first detection window 202-1, e.g. following ejection of a drop from a first nozzle such as the nozzle 406 at a first ejection time t_{e,1}, and the second measurement signal 200-2 is determined during a second detection window 202-2, e.g. following ejection of a drop from a second nozzle such as the nozzle 408 or 410 at a second ejection time t_{e,2}. The first detection window 202-1 may for example start at a first starting time t_{1,1} and end at a first ending time t_{2,1} and the second detection window 202-1 may for example start at a second starting time t_{2,1} and end at a second ending time t_{2,2}. The starting and ending times may e.g. be defined relative to the respective ejection time t_{e,1}, t_{e,2}. The measurement signals 200-1, 200-2 may for example be determined by the drop detector 102. The controller may determine a first flight time Δt_{f,1} from the first measurement signal 202-1 and a second flight time Δt_{f,2} from the second measurement signal 202-2, e.g. by determining a first arrival time t_{a,1} from the first measurement signal 202-1 and a second arrival time t_{a,2} from the second measurement signal 202-2 and determining the difference to the respective ejection time t_{e,1}, t_{e,2}.

The controller 106 may determine the adjusted starting time \tilde{t}₁ and the adjusted ending time \tilde{t}₂ based on the flight times for the at least two nozzles. The adjusted starting time \tilde{t}₁ and the adjusted ending time \tilde{t}₂ may for example be used for subsequently determining a measurement signal for a nozzle or a plurality of nozzles, e.g. the at least two nozzles. In one example, the at least two nozzles may be part of a group of nozzles and the adjusted starting and ending times may be used for nozzles of this group of nozzles. In another example, the at least two nozzles may be part of a print head and the adjusted starting and ending times may be used for nozzles of this print head.

In some examples, the controller 106 may determine the adjusted starting time \tilde{t}₁ and the adjusted ending time \tilde{t}₂ depending on an average of the flight times for the at least two nozzles or an average of the flight times for a subset of the at least two nozzles, e.g. the nozzles associated with one print head, e.g. nozzles 406, 408 of the print head 302-1. The controller 106 may for example be to determine the adjusted starting time \tilde{t}₁ and the adjusted ending time \tilde{t}₂ similar to the device 100, but by using the average of the flight times instead of the flight time Δt_{f} of one nozzle. The controller 106 may e.g. be to compare the average of the flight times to a reference time, which may for example characterize the average center of the detection windows 202-1, 202-1 relative to the respective ejection time t_{e,1}, t_{e,2}.

The controller 106 may determine a plurality of adjusted starting and ending times based on the flight times for the at least two nozzles. In one example, the controller 106 may determine an adjusted detection window, including a respective adjusted starting time and a respective adjusted ending time for each of the at least two nozzles. In other examples, the controller 106 may determine a respective adjusted starting time and a respective adjusted ending time for groups of nozzles of the printing device 400 or for print heads 302-1, 302-2 of the printing device 400, e.g. a first adjusted starting time and a first adjusted ending time for a first group of nozzles and a second adjusted starting time and a second adjusted ending time for a second group of nozzles. To determine an adjusted starting time and an adjusted ending time, the controller 106 may e.g. take into account flight times of nozzles associated with the respective group of nozzles or the respective print head.

In some examples, the controller 106 may determine a first adjusted starting time \tilde{t}_{1,1} and a first adjusted ending time \tilde{t}_{2,1} for a first print head, e.g. the print head 302-1, depending on a first flight time Δt_{f,1} of a nozzle of the first print head 302-1, e.g. the nozzle 406. The controller 106 may further be to determine a second adjusted starting time \tilde{t}_{1,2} and a second adjusted ending time \tilde{t}_{2,2} for a second print head, e.g. the print head 302-2, depending on a second flight time Δt_{f,2} of a nozzle of the second print head 302-2, e.g. the nozzle 410. In some examples, the controller 106 may determine the first and/or second adjusted starting and ending times from flight times of at least two nozzles of the respective print head, e.g. as described above.

In the example of FIG. 5a, the first measurement signal 200-1 may e.g. be associated with the nozzle 406 of the first print head 302-1 and the second measurement signal 200-2 may e.g. be associated with the nozzle 410 of the second print head 302-2. As shown in FIG. 5a, the first flight time Δt_{f,1} may be shorter than the second flight time Δt_{f,2}. The flight times Δt_{f,1}, Δt_{f,2} may e.g. be different because a distance to the drop detector 102 is different for the print head 302-1 than for the print head 302-2 and/or because a drop velocity is different for the print head 302-1 than for the print head 302-2. Due to the shorter flight time, a drop feature such as the minimum of the first measurement signal 200-1 may be close to the starting time t_{1,1} or the ending time t_{2,1} of the first detection window 202-1 and may thus lie outside of the first detection window 202-1 at least in part.

In this example, the controller 106 may e.g. determine a first adjusted starting time \tilde{t}_{1,1} that is smaller than the starting time t_{1,1}, i.e. may shift the first detection window 202-1 closer to the ejection time t_{e,1}. The controller 106 may also determine a first adjusted ending time \tilde{t}_{2,1} that is smaller than the ending time t_{2,1}, e.g. such that a width of the first detection windows 202-1 remains constant. The controller 106 may further determine a second adjusted starting time \tilde{t}_{1,2} and a second adjusted ending time \tilde{t}_{2,2}, e.g. to center the second detection window 202-2 on a drop feature of the second measurement signal 200-2, i.e. such that the arrival time t_{a,2} would correspond to the center of the adjusted second detection window.

In some examples, the controller 106 may further be to perform a functionality test of a nozzle, e.g. a second nozzle 408 different from the nozzle 406 for which the flight time was determined. Performing the functionality test of the second nozzle 408 may comprise ejecting a drop of the printing fluid from the second nozzle 408 at an ejection time and determining a measurement signal during the adjusted detection window. Performing the functionality test of the second nozzle 408 may further comprise determining whether the drop was ejected from the second nozzle 408 and/or determining a drop parameter of the drop ejected from the second nozzle. The drop parameter may for example be a velocity of the drop or a size or volume of the drop. The velocity may e.g. be determined from an arrival time of the drop and the size or volume of the drop may e.g. be determined from a drop signature, e.g. a duration or amplitude of a drop signature. This may comprise fitting the drop signature with a fit function.

An example for this is shown in FIG. 5b, in which four measurement signals 500-1, 500-2, 500-3, 500-4 are illustrated. The four measurement signals 500-1 to 500-4 may for example be associated with four different nozzles. Two measurement signals 500-1, 500-3 are determined during first adjusted detection windows 502-1, 502-3 using the first adjusted starting and ending times, \tilde{t}_{1,1} and \tilde{t}_{2,1}, which may e.g. have been determined previously for the nozzle 406 as described above. The other two measurement signals 500-2, 500-4 are determined during second adjusted detection windows 502-2, 502-4 using the second adjusted starting and ending times, \tilde{t}_{1,2} and \tilde{t}_{2,2}, which may e.g. have been determined previously for the nozzle 410 as described above. The measurement signals 500-1, 500-3 may for example be associated with two nozzles of the same print head as the nozzle for which the first adjusted detection window was determined, e.g. the print head 302-1 comprising the nozzle 406. The measurement signals 500-2, 500-4 may for example be associated with the same print head as the nozzle for which the second adjusted detection window was determined, e.g. the print head 302-2 comprising the nozzle 410. In other words, the first adjusted starting and ending times, \tilde{t}_{1,1} and \tilde{t}_{2,1}, may be used for nozzles of a first print head and the second adjusted starting and ending times, \tilde{t}_{1,2} and \tilde{t}_{2,2}, may be used for nozzles of a second print head.

In one example, the measurement signal 500-1 may be associated with the nozzle 406 like the measurement signal 200-1. Accordingly, the measurement signal 500-2 may be associated with the nozzle 410 like the measurement signal 200-2. Using the adjusted starting and ending times, e.g. \tilde{t}_{1,1} and \tilde{t}_{2,1}, instead of the starting and ending times, e.g. t_{1,1} and t_{2,1}, may facilitate detection of a drop signature as well as determination of the arrival time t_{a,1} and a drop parameter. The measurement signal 500-3 may e.g. be associated with the nozzle 408. A minimum in the measurement signal 500-3 may be comparable to a minimum in the measurement signal 500-1 in position, width and/or amplitude and may indicate a functioning nozzle. The measurement signal 500-4 may e.g. be associated with a nozzle of the second print head 302-2. A minimum in the measurement signal 500-4 may be different from a minimum in the measurement signal 500-2 in position, width and/or amplitude and may indicate a clogged or non-functioning nozzle, e.g. due to a reduced amplitude of the minimum as shown in FIG. 5b.

The controller 106 may further be to align the print head 302-1, 302-2 and the drop detector 102 based on a measurement signal determined using the adjusted detection window, e.g. one of the measurement signals 500-1 to 500-4 determined using the respective adjusted detection window 502-1 to 502-4. To align the print head 302-1, 302-2 and the drop detector 102, the controller 106 may e.g. be to move the drop detector and/or the print head 302-1, 302-2, for example by moving the print head carriage 402. The controller 106 may for example align the print head 302-1, 302-2 and the drop detector 102 along the scanning direction “X” and/or along a media advance direction of a print medium in the printing device 400. The controller 106 may e.g. align the print head 302-1, 302-2 and the drop detector 102 by maximizing a width and/or amplitude of a drop signature. Aligning the print head 302-1, 302-2 and the drop detector 102 may facilitate determining a drop parameter and/or assessing the functionality of a nozzle.

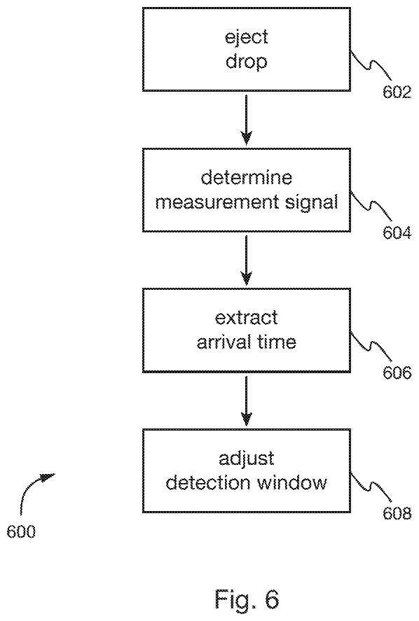

FIG. 6 illustrates a flow chart of a method 600 of calibrating a printing device in accordance with an example. The method 600 is for calibrating a printing device having a nozzle that is to eject a drop of a printing fluid and a sensor that is to detect a drop of the printing fluid at a detection position. The method 600 may e.g. be executed when the printing device is switched on, after a predetermined calibration time, prior to execution of a print job and/or based on a calibration request, e.g. by a user of the printing device. The method 600 may for example be executed with the printing device 300 having the nozzle 304 and the sensor or drop detector 102, wherein the detection position may for example be a position within the measurement zone 104, e.g. the center of the measurement zone 104. The method 600 will be described in the following with reference to FIGS. 2, 3 and 6 using the printing device 300 as an example. This is, however, not intended to be limiting in any way and the method 600 may be executed with other printing devices, e.g. the printing device 400 or a printing device comprising the device 100.

The method 600 comprises, at block 602, ejecting a drop 108 of the printing fluid from the nozzle 304. The drop 108 may e.g. be ejected by sending a corresponding command signal or trigger signal to the print head 302 or a main controller of the printing device 300. The drop 108 may e.g. be ejected at an ejection time tₑ.

The method 600 further comprises, at block 604, determining a measurement signal 200 during a detection window 202 with the sensor 102. Block 604 may comprise sending a command signal or trigger signal to the sensor 102, e.g. to initiate a measurement at a starting time t₁ of the detection window 202 and/or to stop the measurement at an ending time t₂ and/or after a duration ΔT. Block 604 may further comprise reading out the measurement signal from the sensor 102, e.g. by the controller 106. In some examples, block 604 may comprise post-processing a continuous measurement signal of the sensor 102 to obtain the measurement signal 200, e.g. as described above with reference to FIGS. 1 and 2. Determining the measurement signal 200 during the detection window 202 with the sensor 102 may further comprise finding a drop signature, e.g. as described below for block 702 of method 700.

The method 600 also comprises, at block 606, extracting an arrival time tₐ of the drop from the measurement signal 200, e.g. as described above for the device 100. Block 606 may comprise identifying a drop signature, e.g. an extremum like a minimum or a maximum, in the measurement signal 200 and extracting the arrival time tₐ from the drop signature, e.g. a point in time at which the drop signature occurs. This may comprise fitting the drop signature with a fit function. In some examples, block 606 may also comprise determining a flight time Δt_{f}, e.g. based on the arrival time tₐ.

The method 600 further comprises, at block 608, determining an adjusted detection window by adjusting the detection window 202 based on the arrival time tₐ, e.g. as described above for the device 100. Determining the adjusted detection time may comprise adjusting at least one of the starting point t₁ and the width ΔT of the detection window 202, e.g. based on a comparison with a reference time. In some examples, adjusting the detection window 202 comprises shifting the detection window 202 relative to the ejection time tₑ, e.g. by adjusting the starting point t₁ and the ending point t₂ by an offset without changing the width ΔT. Additionally or alternatively, the ejection time tₑ may also be adjusted. In some examples, adjusting the detection window 202 comprises comparing the arrival time tₐ with a reference time t₀ within the detection window 202 and shifting the detection window 202 by an amount corresponding to the difference between the arrival time tₐ and the reference time t₀, for example as described above for the device 100.

The adjusted detection window may be used for a subsequent determination of a measurement signal for a nozzle or a plurality of nozzles, e.g. a group of nozzles or a print head that the nozzle 304 is associated with. The subsequent determination of the measurement signal may for example be for performing a functionality test of a nozzle, e.g. as detailed below for blocks 712, 714 of the method 700. The adjusted detection window may be used until the method 600 is executed again, e.g. for a predetermined calibration time, a predetermined number of functionality tests or print jobs, until the printing device 300 is switched off or until a new calibration request is received. In some examples, the method 600 may be repeated whenever a calibration parameter like the difference between an arrival time and a reference time is above a predetermined calibration threshold. The calibration parameter may e.g. be determined by the controller 106 when performing a functionality test.

In some examples, the adjusted detection window may be determined iteratively, e.g. by repeating the method 600 for a predetermined number of times and/or until a predetermined accuracy threshold is reached, for example as detailed below for method 700.

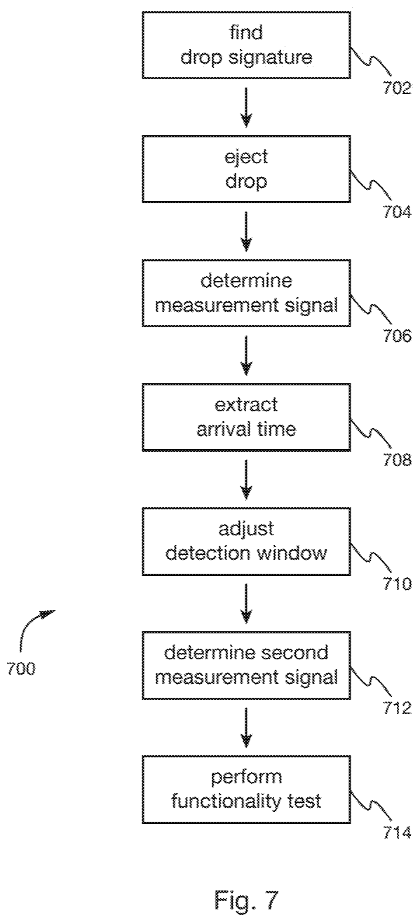

FIG. 7 illustrates a flow chart of another method 700 of calibrating a printing device in accordance with an example. The method 700 may for example be executed with the printing device 400 and will be described in the following with reference to FIGS. 4, 5 and 6 using the printing device 400 as an example. This is, however, not intended to be limiting in any way and the method 700 may be executed with other printing devices, e.g. the printing device 300 or a printing device comprising the device 100. Furthermore, the flow chart of FIG. 7 does not indicate a certain order of execution of the method 700. As far as technically feasible, the method 700 may be executed in an arbitrary order and parts of the method 700 may be executed simultaneously at least in part.

The method 700 may comprise, at block 702, finding a drop signature. This may comprise determining an initial measurement signal during an initial detection window with the sensor 102. The initial detection window may e.g. be defined by a predetermined initial starting time and a predetermined initial width, which may e.g. be stored in the controller 102 or a memory of the printing device 400. In some examples, the predetermined initial starting time and width may have been obtained prior to execution of the method 700 based on an adjusted detection window determined previously, e.g. during an earlier execution of the method 600 or 700.

Block 702 may further comprise determining whether the initial measurement signal contains a drop signature, e.g. an extremum. This may e.g. comprise comparing a minimum or maximum value of the initial measurement signal with a threshold value, e.g. a predetermined threshold value or an average of the initial measurement signal, and/or fitting a fit function to the initial measurement signal. If it is determined that the initial measurement signal does not contain a drop signature, block 702 may also comprise iteratively changing at least one of a width or a starting point of the initial detection window until a drop signature is found. In some examples, the starting point of the initial detection window may be increased or decreased iteratively using a predetermined step size. Additionally or alternatively, the width of the initial detection window may be increased iteratively using a predetermined step size.

The method 700 further comprises, at block 704, ejecting a drop 108 of the printing fluid from a nozzle, e.g. as in block 602 of method 600. In some examples, an ejection time tₑ of the drop 108 may be determined based on a detection window determined in block 702, e.g. to ensure that a measurement signal determined subsequently in block 706 contains a drop signature. Block 704 may comprise ejecting drops from a plurality of nozzles, e.g. at least two nozzles, for example a drop from the nozzle 406 at an ejection time t_{e,1} and a drop from the nozzle 408 or 410 at an ejection time t_{e,2}. In some examples, the at least two nozzles may be part of a group of nozzles or of a print head, e.g. to determine an adjusted detection window for this group of nozzles or print head. In other examples, the at least two nozzles may be part of a plurality of nozzle groups and/or of a plurality of print heads, e.g. to determine respective adjusted detection windows for each of the groups of nozzles or for each of the print heads.

The method 700 further comprises, at block 706, determining a measurement signal during a detection window with the sensor 102, e.g. as in block 604 of method 600. In some examples, block 706 may comprise determining respective measurement signals during respective detection windows with the sensor 102 for each of the at least two nozzles. Block 706 may e.g. comprise determining a first measurement signal 200-1 during a first detection window 202-1 for a first nozzle, e.g. the nozzle 406, and determining a second measurement signal 200-2 during a second detection window 202-2 for a second nozzle, e.g. the nozzle 408 or the nozzle 410, for example as described above with reference to FIG. 5a.

The method 700 also comprises, at block 708, extracting an arrival time of the drop from the measurement signal, e.g. as in block 606 of method 600. Block 708 may comprise determining respective arrival times of drops from the respective measurement signal for each of the at least two nozzles for which measurement signals were determined in block 706. In the example of FIG. 5a, block 708 may e.g. comprise determining a first arrival time t_{a,1} from the first measurement signal 200-1 and a second arrival time t_{a,2} from the second measurement signal 200-2.

The method 700 further comprises, at block 710, determining an adjusted detection window by adjusting the detection window based on the arrival time, e.g. as in block 608 of method 600. Block 710 may comprise determining respective adjusted detection windows for each of a plurality of nozzles based on the at least two arrival times extracted in block 708. The plurality of nozzles may be nozzles of one print head, e.g. the nozzles 304-1 of print head 302-1 or a subset thereof, or may be nozzles of multiple print heads, e.g. the nozzles 304-1, 304-2 of print heads 302-1, 302-2 or a subset thereof. In some examples, an adjusted detection window may be determined for a group of nozzles or a print head. In other examples, respective adjusted detection windows may be determined for each group of a plurality of nozzles groups and/or for each of a plurality of print heads.

An adjusted detection window for a nozzle may be determined using all of the at least two arrival times extracted in block 708 or a subset thereof, wherein the subset may be different for each nozzle, each group of nozzles or each print head. In one example, the same subset may be used for each nozzle associated with a given print head or a given group of nozzles. In the example of FIGS. 5a and 5b, first adjusted detection windows 502-1, 502-3 may e.g. be determined for the nozzle 406 and 408, respectively, based on the arrival time t_{a,1} associated with a nozzle of the first print head 302-1, e.g. the nozzle 406. Second adjusted detection windows 502-2, 502-4 may e.g. be determined for nozzles of the second print head 302-2 based on the arrival time t_{a,2} associated with a nozzle of the second print head 302-2, e.g. the nozzle 410.

In some examples, each of the adjusted detection windows may be determined based on an average of the at least two arrival times or a subset thereof. The adjusted detection windows may be similar, i.e. may be defined by the same adjusted starting and ending times. In one example, the measurement signals 200-1, 200-2 of FIG. 5a may e.g. be associated with nozzles of the same group of nozzles or of the same print head, e.g. nozzles 406, 408 of print head 302-1, and the adjusted starting and ending times \tilde{t}_{1,1} and \tilde{t}_{2,1} may be determined based on the average of the arrival times t_{a,1} and t_{a,2}, e.g. by comparison with a reference time t₀. Adjusted detection windows 502-1, 502-3 defined by \tilde{t}_{1,1} and \tilde{t}_{2,1} may e.g. be used for each nozzle of the respective group of nozzles or the respective print head 302-1.

The method 700 may further comprise, at block 712, ejecting a second drop of the printing fluid from a nozzle and determining a measurement signal during the adjusted detection window with the sensor 102. In some examples, the second drop may be ejected from a nozzle from which a drop was ejected in block 704 and/or an arrival time was determined in block 708, e.g. the nozzle 406. Additionally or alternatively, the second drop may be ejected from a nozzle from which no drop was ejected in block 704 and/or no arrival time was determined in block 708, e.g. the nozzle 408. Block 712 may comprise ejecting drops from a plurality of nozzles and determining respective measurement signals during the respective adjusted detection window, e.g. as shown in FIG. 5b.

The measurement signal determined during the adjusted detection window may e.g. be used to perform a functionality test as described below for block 714 or may be used to refine the adjusted detection window. In some examples, the adjusted detection window may be determined iteratively by repeating steps 704-710, e.g. using a predetermined number of iterations steps, for example between 2 and 10 iteration steps, or until an amount of a difference between the arrival time t_{a,1} and a reference time t₀ is below a predetermined accuracy threshold.

The method 700 may also comprise, at block 714, performing a functionality test for a nozzle of the print head. The functionality test may be performed using the measurement signal determined during the adjusted detection window in block 712 or may comprise ejecting a drop of the printing fluid from the nozzle to be tested and determining a measurement signal during the adjusted detection window with the sensor 102 similar to block 712. The functionality test may for example be performed as described above for the printing device 400 with reference to FIG. 5b. Block 714 may comprise identifying a drop signature in the measurement signal and assessing functionality of the nozzle based on the drop signature. This may comprise comparing a shape, width and/or amplitude of the drop signature to a reference value. Block 714 may further comprise determining an arrival time of the drop and/or a drop parameter such as a velocity or volume of the drop, e.g. from the drop signature. Block 714 may also comprise comparing the arrival time and/or drop parameter to a reference value, e.g. to assess whether the nozzle is functioning. In some examples, block 714 may further comprise determining whether a calibration parameter like the difference between the arrival time and a reference time is above a predetermined calibration threshold, e.g. to determine whether to repeat the method 700 to obtain a new adjusted detection window.

In some examples, the method 600 and/or the method 700 may comprise additional blocks, e.g. aligning a print head and a drop detector as described above for the printing device 400, servicing and/or cleaning a non-functioning nozzle, storing information pertaining to a status of a nozzle and/or storing information pertaining to an adjusted detection window.

The description is not intended to be exhaustive or limiting to any of the examples described above. The method of calibrating a printing device, the detector and the printing device disclosed herein can be implemented in various ways and with many modifications without altering the underlying basic properties.

1. A method of calibrating a printing device having
a nozzle that is to eject a drop of a printing fluid; and
a sensor that is to detect a drop of the printing fluid at a detection position,
the method comprising:
ejecting a drop of the printing fluid from the nozzle;
determining a measurement signal during a detection window with the sensor;
extracting an arrival time of the drop from the measurement signal; and
determining an adjusted detection window by adjusting the detection window based on the arrival time.

2. The method of claim 1, wherein adjusting the detection window comprises shifting the detection window relative to an ejection time.

3. The method of claim 2, wherein adjusting the detection window comprises comparing the arrival time with a reference time within the detection window and shifting the detection window by an amount corresponding to the difference between the arrival time and the reference time.

4. The method of claim 1, wherein the printing device comprises a plurality of nozzles and the method further comprises:
for at least two of the nozzles, determining respective measurement signals during respective detection windows with the sensor for each of the at least two nozzles and determining respective arrival times of drops from the respective measurement signal for each of the at least two nozzles; and
determining respective adjusted detection windows for each of the nozzles based on the at least two arrival times.

5. The method of claim 4, wherein each of the adjusted detection windows is determined based on an average of the at least two arrival times.

6. The method of claim 1, further comprising
ejecting a second drop of the printing fluid from a nozzle; and
determining a measurement signal during the adjusted detection window with the sensor.

7. The method of claim 1, wherein determining the measurement signal during the detection window with the sensor comprises:
determining an initial measurement signal during an initial detection window with the sensor;
determining whether the initial measurement signal contains a drop signature; and
if the initial measurement signal does not contain a drop signature, iteratively changing at least one of a width or a starting point of the initial detection window until a drop signature is found.

8. A detector for use in a printing device, the detector comprising:
a sensor that is to generate a measurement signal during a detection window, wherein the measurement signal characterizes an amount of a printing fluid in a measurement zone; and
a controller that is to read out the measurement signal from the sensor,
wherein the controller is to:
determine an arrival time of a drop of a printing fluid in the measurement zone from the measurement signal; and
adjust at least one of a starting point and a width of the detection window based on a comparison between the arrival time and a reference time.

9. The detector of claim 8, wherein the controller is to
determine the arrival time by identifying an extremum in the measurement signal; and
adjust the detection window if no extremum is identified in the measurement signal.

10. The detector of claim 8, wherein
the sensor comprises a light source and a photodetector; and
the measurement signal characterizes an intensity of light incident on the photodetector.

11. A printing device comprising:
a print head that is to eject a drop of a printing fluid from a nozzle of the print head;
a drop detector that is to determine a measurement signal during a detection window, wherein the measurement signal characterizes the presence or absence of a drop at the drop detector; and
a controller;
wherein the controller is to
determine a flight time between ejection of a drop from the nozzle and arrival of the drop at the drop detector from the measurement signal,
determine a starting time and an ending time for an adjusted detection window depending on the flight time, wherein the starting and ending times are determined relative to an ejection time.

12. The printing device of claim 11, wherein the print head comprises a plurality of nozzles and the controller is to determine respective flight times for at least two nozzles using the drop detector and to determine the starting time and the ending time depending on an average of the flight times for the at least two nozzles.

13. The printing device of claim 11 comprising at least two print heads, wherein the controller is to determine starting and ending times for a first print head depending on a flight time of a nozzle of the first print head and starting and ending times for a second print head depending on a flight time of a nozzle of the second print head.

14. The printing device of claim 11, wherein the controller is further to perform a functionality test of a second nozzle by ejecting a drop of the printing fluid from the second nozzle at an ejection time and determining a measurement signal during the adjusted detection window.

15. The printing device of claim 11, wherein the controller is further to align the print head and the drop detector based on a measurement signal determined using the adjusted detection window.
